(19) United States
(12) Patent Application Publication
(10) Pub. No.: US 2016/0012452 A1
(43) Pub. Date: Jan. 14, 2016

(54) METHOD AND SYSTEM FOR DETERMINING CARD HOLDER PREFERENCE

(71) Applicant: MASTERCARD INTERNATIONAL INCORPORATED, Purchase, NY (US)

(72) Inventors: Kenny Unser, Fairfield, CT (US); Jean Pierre Gerard, Croton-on-Hudson, NY (US); Kent Olof Niklas Berntsson, Rye, NY (US)

(21) Appl. No.: 14/329,054

(22) Filed: Jul. 11, 2014

(51) Int. Cl. G06Q 30/02

(52) U.S. Cl. CPC G06Q 30/0201; G06Q 30/0255

(57) ABSTRACT

A method for determining payment card holder preference of a merchant from a grouping of proximal merchant competitors is provided. The method includes retrieving a first set of information including purchasing and payment activity information attributable to payment card holder(s); retrieving a second set of information including merchant information; optionally retrieving a third set of information including external information; analyzing the second set of information and optionally the third set of information to generate grouping(s) of proximal merchant competitors; associating the purchasing and payment activity information attributable to the payment card holders and the groupings of proximal merchant competitors to generate predictive payment card holder profile(s); and determining payment card holder preference of a merchant from a grouping of proximal merchant competitors based on the predictive payment card holder profile(s). A system for determining payment card holder preference of a merchant from a grouping of proximal merchant competitors is also provided.

### BACKGROUND OF THE DISCLOSURE

1. Field of the Disclosure

The present disclosure relates to a method and a system for determining payment card holder preference of a merchant from a grouping of proximal merchant competitors through the generation of predictive payment card holder profiles that are based upon purchasing and payment activity information attributable to the payment card holders, merchant information and optionally external information. The present disclosure also relates to a method and a system for making targeted offers to payment card holders through generation of the predictive payment card holder profiles.

2. Description of the Related Art

Marketing expenses are often one of the largest cost categories for an organization. Marketing difficulties in effectively capturing and reaching the correct population of payment card holders is an industry wide problem, regardless of goods or services offered. In an attempt to overcome these difficulties, entities often engage in various advertising techniques to a broad audience hoping to reach interested payment card holders. However, such broad advertising techniques are often ignored by payment card holders or fail to reach the intended audience.

Information on payment card holders or potential purchasers can be very important to sellers of goods and services. Advertisers benefit from having detailed information about buying preferences, interests or capacities of potential purchasers of goods or services. If an advertiser, for instance, can identify and selectively advertise to those potential purchasers who fit a profile of probable purchasers of the advertiser's goods or services, the advertiser can reduce advertising costs by advertising directly to those potential purchasers. In other words, if the advertiser has both information about potential purchasers and more targeted access for its messages, it can achieve more purchasers/customers for the same amount of money. Useful financial and demographic information for such a strategy includes a potential purchaser's financial status, age, residence, preferences and interests in various goods and services.

If an advertiser has access to such financial and demographic information about a potential purchaser, the advertiser can potentially selectively market to the more promising purchasers for a decreased expense per sales transaction. The money saved by the advertiser can, potentially, be used to reduce the price of the good or service to the purchaser. Instead of advertising to the masses of potential purchasers, the advertiser can concentrate on specific potential purchasers who may be likely to buy a specific good or service and offer favorable pricing.

Using relevant data, consumer activities and characteristics typically provide an effective form of targeted marketing by creating a shopping experience that is personalized and relevant to the consumer. However, targeted marketing systems are often limited to accessing only a specific set of data that provides less than a holistic view of a consumer's spending habits and preferences, in particular, merchant preferences when there are several proximal merchant competitors to choose from. There is a need to identify merchant preferences of a consumer for effective targeted marketing.

Businesses and merchants are constantly seeking ways to operate in a sales environment where they are able to deliver advertising messages and offers to their target audience at the opportune time. For many, the best time for reaching potential consumers is at a time when the consumer is approaching the sales area, or when they are physically in the sales area. In such instances, there is a need to provide advertising messages and offers to payment card holders just-in-time, and at the right place, to enhance the sale of goods and services to potential customers.

Therefore, a need exists for a system that can identify merchant preferences of a consumer and provide a more effective form of targeted marketing by creating a shopping experience that is more personalized and relevant to the consumer, and that is delivered to the consumer at an opportune time. A more holistic view of a consumer's personal circumstances, including preferences (e.g., merchant preferences) and spending habits, is needed for effective targeted marketing. Further, a need exists for a system that can analyze a customer's personal circumstances and preferences, and identify customer activities and circumstances that may represent an opportunity for a merchant to offer products or services to the customer, and which products and/or services are specifically tailored to the customer's upcoming need or desire, and communicate the offers to the customer.

### SUMMARY OF THE DISCLOSURE

The present disclosure relates to a method and a system for determining payment card holder preference of a merchant from a grouping of proximal merchant competitors through the generation of predictive payment card holder profiles that are based upon purchasing and payment activity information attributable to the payment card holders, merchant information and optionally external information.

The present disclosure also relates to a method and a system for making a targeted offer by an entity to payment card holders, specifically for the entity associating or otherwise partnering with a financial transaction processing entity to identify ideal payment card holders, for marketing purposes through the generation of predictive payment card holder profiles that are based upon purchasing and payment activity information attributable to the payment card holders, merchant information and optionally external information, and to enable the entity to make a targeted offer to the payment card holders.

The present disclosure provides a method for determining payment card holder preference of a merchant from a grouping of proximal merchant competitors. The method involves retrieving, from one or more databases, a first set of information including purchasing and payment activity information attributable to one or more payment card holders; retrieving, from one or more databases, a second set of information including merchant information associated with the purchasing and payment activity; and optionally retrieving, from one or more databases, a third set of information including external information. The method further involves analyzing the second set of information and optionally the third set of information to generate one or more groupings of proximal merchant competitors; associating the purchasing and payment activity information attributable to one or more payment card holders and the one or more groupings of proximal merchant competitors to generate one or more predictive payment card holder profiles; and determining payment card holder preference of a merchant from a grouping of proximal merchant competitors based on the one or more predictive payment card holder profiles.

The present disclosure also provides a system for determining payment card holder preference of a merchant from a grouping of proximal merchant competitors. The system includes one or more databases comprising a first set of information including purchasing and payment activity information attributable to one or more payment card holders; one or more databases comprising a second set of information including merchant information associated with the purchasing and payment activity; and optionally one or more databases comprising a third set of information including external information. The system also includes a processor configured to: analyze the second set of information and optionally the third set of information to generate one or more groupings of proximal merchant competitors; associate the purchasing and payment activity information attributable to one or more payment card holders and the one or more groupings of proximal merchant competitors to generate one or more predictive payment card holder profiles; and determine payment card holder preference of a merchant from a grouping of proximal merchant competitors based on the one or more predictive payment card holder profiles. In this and other embodiments, the one or more databases can be the same databases or some of the same databases or entirely different databases.

The present disclosure further provides a method for generating one or more predictive payment card holder profiles. The method involves retrieving, from one or more databases, a first set of information including purchasing and payment activity information attributable to one or more payment card holders; retrieving, from one or more databases, a second set of information including merchant information associated with the purchasing and payment activity; and optionally retrieving, from one or more databases, a third set of information including external information. The method also involves analyzing the first set of information, the second set of information and optionally the third set of information to determine behavioral information of the payment card holders; extracting information related to an intent of the payment card holders from the behavioral information; and generating one or more predictive payment card holder profiles based on the behavioral information and intent of the payment card holders with the payment card holders having a propensity to carry out certain activities based on the one or more predictive payment card holder profiles.

The methods and systems of this disclosure afford several advantages. For example, merchant preferences can be assigned to payment card holders to support targeted marketing and advertising. Also, merchants can be assisted with decisions involving site selection and the impact of proximal competitors. Further, commercial developments can be helped to optimize their tenants and the location of those tenants within their property.

These and other systems, methods, objects, features, and advantages of the present disclosure will be apparent to those skilled in the art from the following detailed description of the embodiments and the drawings.

### BRIEF DESCRIPTION OF THE DRAWINGS

FIG. 1 is a block diagram illustrating a high-level view of system architecture of a financial transaction processing system in accordance with exemplary embodiments.

FIG. 2 illustrates a data warehouse shown in FIG. 1 that is a central repository of data that is created by storing certain transaction data from transactions occurring within four party payment card system of FIG. 1.

FIG. 3 shows illustrative information types used in the systems and the methods of the present disclosure.

FIG. 4 shows illustrative merchants in selected industry categories in accordance with exemplary embodiments of this disclosure.

FIG. 5 illustrates an exemplary dataset for the storing, reviewing, and/or analyzing of information used in the systems and the methods of this disclosure.

FIG. 6 is a block diagram illustrating a method for determining payment card holder preference of a merchant from a grouping of proximal merchant competitors in accordance with exemplary embodiments of this disclosure.

FIG. 7 is a block diagram illustrating a method for generating one or more predictive payment card holder profiles in accordance with exemplary embodiments of this disclosure.

FIG. 8 is a block diagram illustrating a method for making a targeted offer by a merchant to payment card holders in accordance with exemplary embodiments of this disclosure.

A component or a feature that is common to more than one figure is indicated with the same reference number in each figure.

### DESCRIPTION OF THE EMBODIMENTS

Embodiments of the present disclosure can now be described more fully hereinafter with reference to the accompanying drawings, in which some, but not all, embodiments of the disclosure are shown. Indeed, this disclosure can be embodied in many different forms and should not be construed as limited to the embodiments set forth herein. Rather, these embodiments are provided so that this disclosure may satisfy applicable legal requirements. Like numbers refer to like elements throughout.

As used herein, entities can include one or more persons, organizations, businesses, institutions and/or other entities, including but not limited to, financial institutions, and services providers, that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It can be understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, apparatus, systems, methods and computer program products are herein disclosed to generate predictive payment card holder profiles, to identify, analyze, extract and correlate payment card holder activities and characteristics, merchant information and optionally external information that represent an opportunity to determine payment card holder preference of a merchant from a grouping of proximal merchant competitors, to target offer products or services to the payment card holder, and also an opportunity for predicting payment card holder behavior and intent. Embodiments of the present disclosure will leverage the information available to identify data that is indicative of a payment card holder's activities and characteristics, and to predict payment card holder behavior and intent based on those activities and characteristics (e.g., a preference for one merchant from a grouping of proximal merchant competitors). Such activities and characteristics can include, but are not limited to, spending behavior, merchant preference, geography, age, gender, and the like. By identifying and analyzing payment card holder activities and characteristics based on predictive payment card holder profiles, one can offer products and services that are relevant to the payment card holder's needs.

In particular, for example, when a person (e.g., payment card holder) fills up with gasoline off a highway exit or visits a food court in a shopping mall, he or she is presented with a set of similar merchants, all competing for the purchase. In those moments, the primary driver for the payment card holder choosing a merchant is their own preference, since a number of merchants are concentrated in a small area with equal convenience to the payment card holder. In accordance with this disclosure, payment card holder preference of a merchant from a grouping of proximal merchant competitors can be determined.

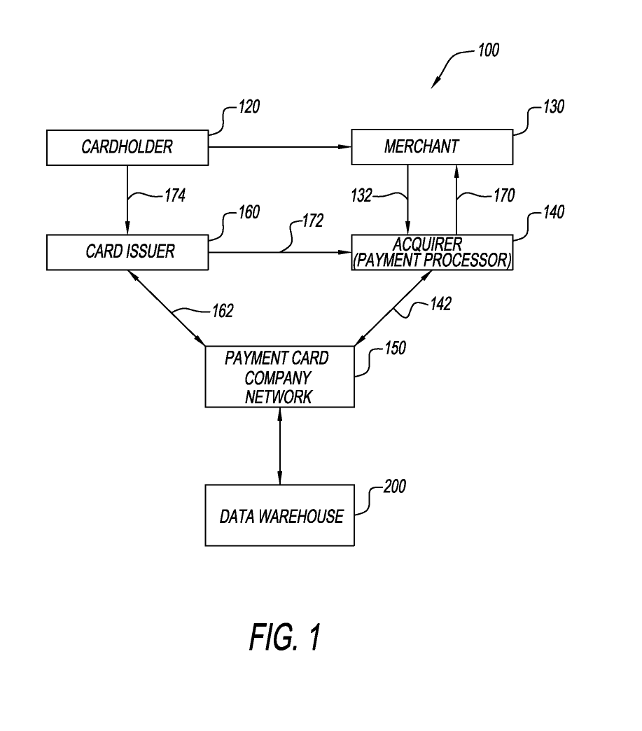

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data which is created by storing certain transaction data from transactions occurring within four party payment card system 100. According to another embodiment, data warehouse 200 stores, for example, the date, time, amount, location, merchant code, and merchant category for every transaction occurring within payment card network 150.

In yet another embodiment, data warehouse 200 stores, reviews, and/or analyzes information used in (i) constructing one or more definitions of payment card transactions and one or more payment card holder lists by payment card transactions, (ii) constructing one or more definitions of payment card transactions, one or more definitions of groupings of proximal merchant competitors, and one or more payment card holder lists by payment card transactions and by groupings of proximal merchant competitors, (iii) creating one or more groupings of payment card transactions and groupings of proximal merchant competitors, (iv) creating one or more datasets to store information relating to the one or more groupings of payment card transactions and one or more groupings of proximal merchant competitors, and (v) creating one or more datasets to store information relating to predictive payment card holder profiles and associations between the one or more groupings of payment card transactions and one or more groupings of proximal merchant competitors.

In still another embodiment, data warehouse 200 stores, reviews, and/or analyzes information used in creating one or more datasets to store information relating to the one or more groupings of payment card transactions and one or more groupings of proximal merchant competitors.

In another embodiment, data warehouse 200 stores, reviews, and/or analyzes information used in developing logic for creating one or more groupings of payment card transactions and one or more groupings of proximal merchant competitors, and applying the logic to a universe of payment card transactions and one or more groupings of proximal merchant competitors to create associations between the payment card transactions and the one or more groupings of proximal merchant competitors.

In still another embodiment, data warehouse 200 stores, reviews, and/or analyzes information used in quantifying the strength of the one or more associations between the one or more payment card holders and the one or more groupings of payment card transactions and the one or more groupings of proximal merchant competitors.

In another embodiment, data warehouse 200 stores, reviews, and/or analyzes information, with respect to the one or more associations between the one or more payment card holders and the one or more groupings of payment card transactions and the one or more groupings of proximal merchant competitors, used in assigning attributes to the one or more payment card holders and the one or more groupings of payment card transactions and one or more groupings of proximal merchant competitors. The attributes are selected from the group consisting of one or more of confidence, time, and frequency.

In yet another embodiment, data warehouse 200 stores, reviews, and/or analyzes information used in identifying one or more payment card holders, one or more groupings of payment card transactions, and one or more groupings of proximal merchant competitors, and strength of the one or more associations between the one or more payment card holders and the one or more groupings of payment card transactions, and one or more groupings of proximal merchant competitors.

In still another embodiment, data warehouse 200 stores, reviews, and/or analyzes information used in generating one or more predictive payment card holder profiles, and one or more associations between the one or more payment card holders and the one or more groupings of payment card transactions, and one or more groupings of proximal merchant competitors.

In yet still another embodiment, data warehouse 200 stores, reviews, and/or analyzes information used in targeting information including at least one or more suggestions or recommendations for payment card holder spending or purchasing activity at a geolocation, based on the one or more associations between the one or more payment card holders and the one or more groupings of payment card transactions and one or more groupings of proximal merchant competitors.

In another embodiment, data warehouse 200 aggregates the information by merchant and/or category and/or location. In still another embodiment, data warehouse 200 integrates data from one or more disparate sources. Data warehouse 200 stores current as well as historical data and is used for creating reports, performing analyses on the network, merchant analyses, and performing predictive analyses.

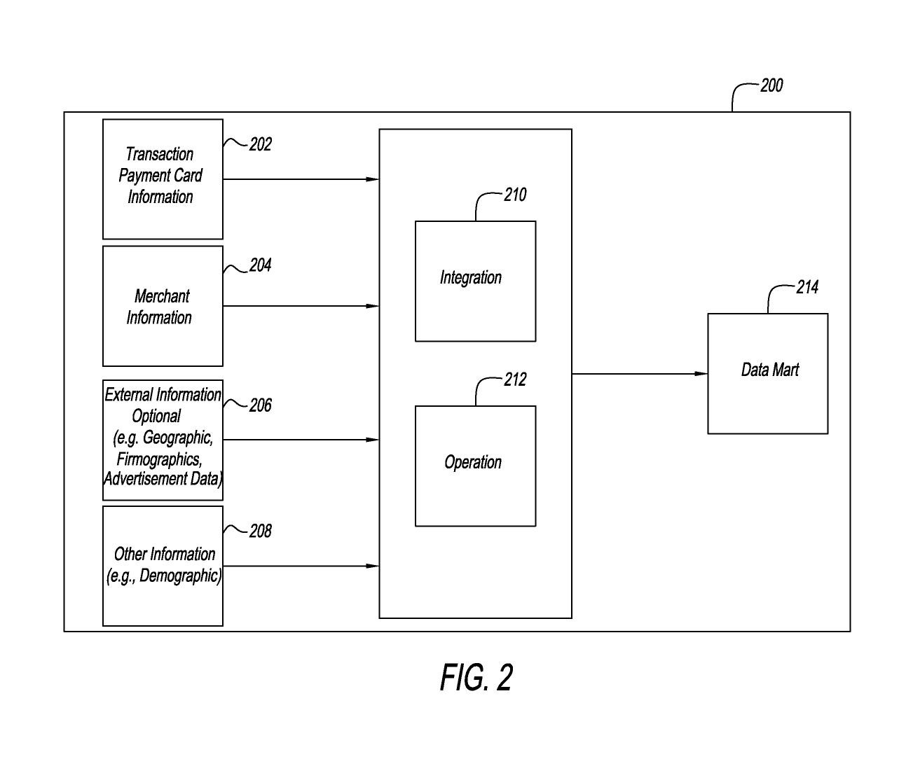

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can contain a plurality of entries (e.g., entries 202, 204, 206 and 208).

The payment card transaction information 202 can contain, for example, purchasing and payment activities attributable to purchasers (e.g., payment card holders), that is aggregated by merchant and/or category and/or location in the data warehouse 200. The merchant information 204 includes, for example, merchant name, merchant geography, merchant line of business, and the like. The optional external information 206 includes, for example, geographic data, firmographic information, advertisement data, and the like. Other information 208 can include demographic or other suitable information that can be useful in constructing one or more definitions of payment card transactions and one or more payment card holder lists by payment card transactions; constructing one or more definitions of payment card transactions, one or more definitions of groupings of proximal merchant competitors, and one or more payment card holder lists by payment card transactions and by groupings of proximal merchant competitors; creating one or more groupings of payment card transactions and groupings of proximal merchant competitors; creating one or more datasets to store information relating to the one or more groupings of payment card transactions and one or more groupings of proximal merchant competitors; and creating one or more datasets to store information relating to predictive payment card holder profiles and associations between the one or more groupings of payment card transactions and one or more groupings of proximal merchant competitors.

The typical data warehouse uses staging, data integration, and access layers to house its key functions. The staging layer or staging database stores raw data extracted from each of the disparate source data systems. The integration layer integrates at 210 the disparate data sets by transforming the data from the staging layer often storing this transformed data in an operational data store database or operation 212. For example, the payment card transaction information 202 can be aggregated by merchant and/or category and/or location at 210, and correlated with merchant information 204 and external information 206 at 210. Also, the reporting and data analysis, including the storing, reviewing, and/or analyzing of information, for the various purposes described above, can occur in data warehouse 200. The integrated data is then moved to yet another database, often called the data warehouse database or data mart 214, where the data is arranged into hierarchical groups often called dimensions and into facts and aggregate facts. The access layer helps users retrieve data.

A data warehouse constructed from an integrated data source systems does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 214 is a small data warehouse focused on a specific area of interest. For example, the data mart 214 can be focused on one or more of reporting and data analysis, including the storing, reviewing, and/or analyzing of information, for any of the various purposes described above. Data warehouses can be subdivided into data marts for improved performance and ease of use in that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the way or means to retrieve and analyze data, to extract, transform and load data, and to manage the data dictionary, are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas in turn can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

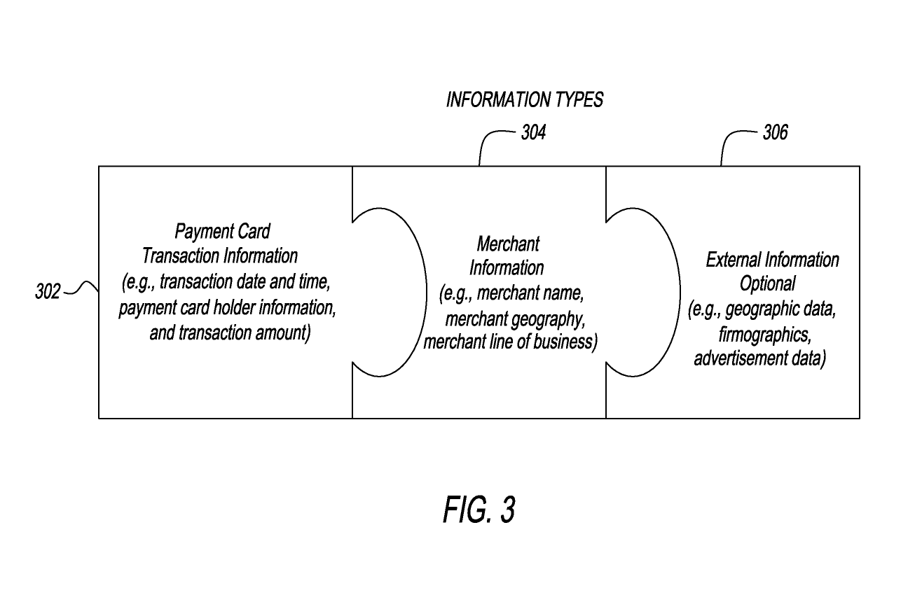

In accordance with the method of the present disclosure, information that is stored in one or more databases can be retrieved (e.g., by a processor). FIG. 3 shows illustrative information types used in the systems and methods of the present disclosure.

The information can contain, for example, a first set of information including payment card transaction information 302. Illustrative first set of information can include, for example, transaction date and time, payment card holder information, and transaction amount. In particular, the payment card transaction information can include, for example, transaction date/time, payment card holder information (e.g., payment card holder account identifier (likely anonymized), payment card holder geography (potentially modeled), payment card holder type (consumer/business), payment card holder demographics, and the like), and payment transaction amount information. The first set of information includes information related to payment card transactions and actual spending. Information for inclusion in the first set of information can be obtained, for example, from payment card companies known as MasterCard®, Visa®, American Express®, and the like (part of the payment card company network 150 in FIG. 1).

The information can also contain, for example, a second set of information including merchant information 304 associated with payment card holder purchasing and payment activity. Illustrative second set of information can include, for example, merchant name, merchant address, merchant location(s) of business, merchant line of business or category, merchant geographic information, and the like.

The second set of information can include categorization of merchants. The one or more databases are used for storing profiles of one or more merchants, and merchants belonging to a particular category, e.g., industry category. Illustrative merchant categories are described herein. The merchant categorization is useful for identifying merchant competitors and generating one or more groupings of proximal merchant competitors.

In an embodiment, a merchant category can include a segment of a particular industry (such as all merchants within a particular geographic region or merchants falling within a specific price range), all merchants in two or more industries (perhaps where merchants in the industries compete for the same customers), and the like. In some embodiments, the merchant category can be defined using merchant category codes according to predefined industries, which can be aligned using standard industrial classification codes, or using the industry categorization described herein.

Merchant categorization indicates the category or categories assigned to each merchant name. As described herein, merchant category information is used primarily for purposes of identifying merchant competitors and generating one or more groupings of proximal merchant competitors, although other uses are possible. According to one embodiment, each merchant name is associated with only one merchant category. In alternate embodiments, however, merchants are associated with a plurality of categories as apply to their particular businesses. Generally, merchants are categorized according to conventional industry codes as defined by a selected external source (e.g., a merchant category code (MCC), Hoovers™, the North American Industry Classification System (NAICS), and the like). However, in one embodiment, merchant categories are assigned based on system operator preferences, or some other similar categorization process.

An illustrative merchant categorization including industry codes is set forth below.

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

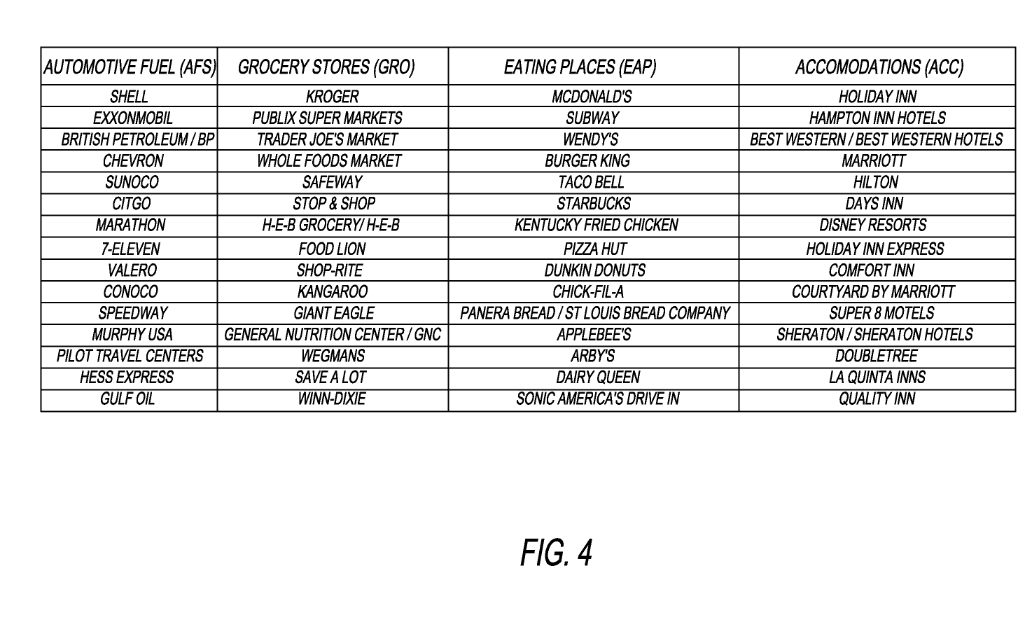

Illustrative merchants and industry categorization are shown in FIG. 4. The illustrative industry categories include AFS Automotive Fuel, GRO Grocery Stores, EAP Eating Places, and ACC Accommodations. Illustrative merchants associated with the industry categories are listed in FIG. 4. In accordance with this disclosure, merchant categorization is important for identifying merchant competitors and generating one or more groupings of proximal merchant competitors. Proper merchant categorization is important to obtain payment card holder preference results that are truly reflective of the particular merchant and industry, in particular, to determine how payment card holder preference is trending for one merchant in comparison to another merchant in the same industry category.

The information can optionally contain, for example, a third set of information including external information. Illustrative external information can include, for example, geographic data, firmographic information, advertisement data, demographic information, and the like. The external information can be obtained from third party sources known in the art.

Referring to FIG. 3, in accordance with the present disclosure, the second set of information, including merchant information associated with payment card holder purchasing and payment activity, can be supplemented or leveraged to enable accurate identification of merchant competitors and groupings of proximal merchant competitors. Illustrative leveraged data sources can include geographic data, firmographics (e.g., line of operations for a business, information related to merchant employees and revenues), risk (e.g., overall credit worthiness of a merchant), and attitudinal (e.g., information related to payment card holder dynamics, satisfaction and concerns with a merchant). These leveraged data sources can supplement information in the second set of information.

The optional external information 306 can include, for example, geographic areas (e.g., zip codes, metropolitan areas (metropolitan statistical area (MSA), designated market area (DMA), and the like). The external information can be categorized, for example, by country, state, zip code, and the like. The geolocations can be clustered (i.e., location clusters) by category, for example, by merchants, activities, events, or other categories. The external information can also include map data (e.g., highway exits, travel time, rest areas, nearest airport, and the like),

The external information 306 can further include firmographics data, for example, line of operations for a business, information related to employees, revenues and industries, and the like. In particular, the firmographics data relates to information on merchants that is typically used in credit decisions, business-to-business marketing and supply chain management.

Illustrative information in the firmographics data source includes, for example, information concerning merchant background, merchant history, merchant special events, merchant operation, merchant payments, merchant payment trends, merchant financial statement, merchant public filings, and the like merchant information.

Merchant background information can include, for example, ownership, history and principals of the merchant, and the operations and location of the merchant.

Merchant history information can include, for example, incorporation details, par value of shares and ownership information, background information on management, such as educational and career history and company principals, related companies including identification of affiliates including, but not limited to, parent, subsidiaries and/or branches worldwide. The merchant history information can also include corporate registration details to verify the existence of a registered organization, confirm legal information such as a merchant's organizational structure, date and state of incorporation, and research possible fraud by reviewing names of principals and business standing within a state.

Merchant special event information can include, for example, any developments that can impact a potential relationship with a company, such as bankruptcy filings, changes in ownership, acquisitions and other events. Other special event information can include announcements on the release of earnings reports. Special events can help explain unusual company trends, for example, a change in ownership could have an impact on manner of payment, or decreased production may reflect an unexpected interruption in factory operations (i.e., labor strike or fire).

Merchant operational information can include, for example, the identity of the parent company, the number of accounts and geographic scope of the business, typical selling terms, and whether the merchant owns or leases its facilities. The names and locations of branch operations and subsidiaries can also be identified.

Merchant payment information can include, for example, a listing of recent payments made by a company. An unusually large number of transactions during a single month or time period can indicate a seasonal purchasing pattern. The information can show payments received prior to date of invoice, payments received within trade discount period, payments received within terms granted, and payments beyond vendor's terms.

Merchant payment trend information can include, for example, information that spots trends in a merchant's business by analyzing how it pays its bills.

Merchant financial statement information can include, for example, a formal record of the financial activities and a snapshot of a merchant's financial health. Financial statements typically include four basic financial statements, accompanied by a management discussion and analysis. The Balance Sheet reports on a company's assets, liabilities, and ownership equity at a given point in time. The Income Statement reports on a company's income, expenses, and profits over a period of time. Profit & Loss accounts provide information on the operation of the enterprise. These accounts include sale and the various expenses incurred during the processing state. The Statement of Retained Earnings explains the changes in a company's retained earnings over the reporting period. The Statement of Cash Flows reports on a company's cash flow activities, particularly its operating, investing and financing activities.

Merchant public filing information can include, for example, bankruptcy filings, suits, liens, and judgment information obtained from Federal and State court houses for a company.

The risk data source includes information related to overall credit worthiness of a merchant including open lines of credit, utilization and risk score. In particular, information for inclusion in the risk data source relates to information concerning credit services, marketing services, decision analytics and consumer services. The risk data source can also include information on people, businesses, motor vehicles and insurance. The risk data source can also include ‘lifestyle’ data from on-line and off-line surveys.

The attitudinal data source includes information related to payment card holder dynamics, satisfaction and concerns. Information for inclusion in the attitudinal data source can be obtained, for example, from payment card companies known as MasterCard®, Visa®, American Express®, and the like (part of the payment card company network 150 in FIG. 1).

The attitudinal information can contain, for example, information from surveys conducted by the financial transaction processing entity (e.g., a payment card company), spending behaviors, payment behaviors, growth opportunities, attitudes in the industry, supply and demand, product trends, and the like.

Advertisement data can include information concerning all forms of advertising including, for example, billboard advertisements on a highway, advertisements on highway road signs, and the like.

While accurate and up-to-date payment card transaction data and merchant data are of primary concern for determining payment card holder preference of a merchant from a grouping of proximal merchant competitors, the additional information described above can also be useful in more fully understanding the merchant and/or contributing to the overall assessment of the payment card holder preference.

With regard to the sets of information, filters can be employed to select particular portions of the information. For example, time range filters can be used that can vary based on need or availability.

In an embodiment, all information stored in each of the one or more databases can be retrieved. In another embodiment, only a single entry in each database can be retrieved. The retrieval of information can be performed a single time, or can be performed multiple times.

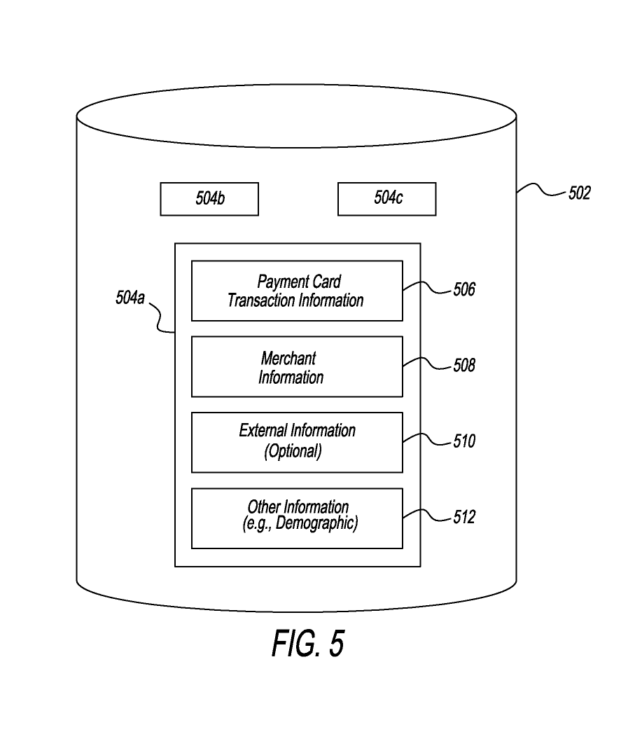

Referring to FIG. 5. an exemplary dataset 502 for the storing, reviewing, and/or analyzing of information used in the systems and methods of the present disclosure is shown. The dataset 502 can contain a plurality of entries (e.g., entries 504a, 504b, and 504c).

As described herein, the payment card transaction information 506 includes payment card transactions and actual spending. The payment card transaction information 506 can contain, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), payment transaction amount information, and the like.

Also, as described herein, the merchant information 508 includes merchant name, merchant address, merchant location(s) of business, merchant line of business or category, merchant geographic information, and the like.

Further, as described herein, the optional external information 510 can include, for example, geographic data, firmographic information, advertisement data, and the like.

The other information 512 includes, for example, demographic or other suitable information that can be useful in conducting the systems and methods of this disclosure.

Algorithms can be employed to determine formulaic descriptions of the integration of the payment card transaction information, the merchant information and the external information using any of a variety of known mathematical techniques. These formulas, in turn, can be used to derive or generate one or more analyses and updates for identifying associations between the payment card transaction information, the merchant information and the external information, and generating one or more predictive payment card holder profiles, using any of a variety of available trend analysis algorithms. For example, these formulas can be used to construct one or more definitions of payment card transactions and one or more payment card holder lists by payment card transactions; construct one or more definitions of payment card transactions, one or more definitions of groupings of proximal merchant competitors, and one or more payment card holder lists by payment card transactions and by groupings of proximal merchant competitors; create one or more groupings of payment card transactions and groupings of proximal merchant competitors; create one or more datasets to store information relating to the one or more groupings of payment card transactions and one or more groupings of proximal merchant competitors; and create one or more datasets to store information relating to predictive payment card holder profiles and associations between the one or more groupings of payment card transactions and one or more groupings of proximal merchant competitors.

In an embodiment, logic is developed for creating one or more groupings of payment card transactions and one or more groupings of proximal merchant competitors. The logic is applied to a universe of payment card transactions and one or more groupings of proximal merchant competitors to create associations between the payment card transactions and the one or more groupings of proximal merchant competitors.

In accordance with the method of the present disclosure, information that is stored in one or more databases can be retrieved (e.g., by a processor). The information can contain, for example, billing activities attributable to the financial transaction processing entity (e.g., a payment card company) and purchasing and payment activities, including date and time, attributable to the payment card holders, merchant information including geographic (e.g., zip code and state or country of residence), external information, and the like. External information can include, for example, geographic data, firmographic information, advertisement data, demographic information, and the like. Other illustrative information can include, for example, demographic (e.g., age and gender), and the like.

In an embodiment, all information stored in each database can be retrieved. In another embodiment, only a single entry in each of the one or more databases can be retrieved. The retrieval of information can be performed a single time, or can be performed multiple times. In an exemplary embodiment, only information pertaining to a specific predictive payment card holder profile is retrieved from each of the databases.

In accordance with this disclosure, a high level process flow involves, for each payment card transaction at a merchant, summarizing the other merchants in the immediate area, if any; determining logical payment card holder groups, merchant competitive sets, industry groupings, geographies, and the like; storing granular information that captures merchant preference in a database; aggregating the data at various levels (e.g., payment card holder level, merchant level, geography, and the like); and delivering a feed of data that can be used for one of the several applications of this disclosure.

The several applications of this disclosure include, for example, merchant preferences assigned to payment card holders to support targeted marketing and advertising; merchants assisted with decisions involving site selection and the impact of proximal competitors; commercial developments helped to optimize their tenants and the location of those tenants within their property; and the like.

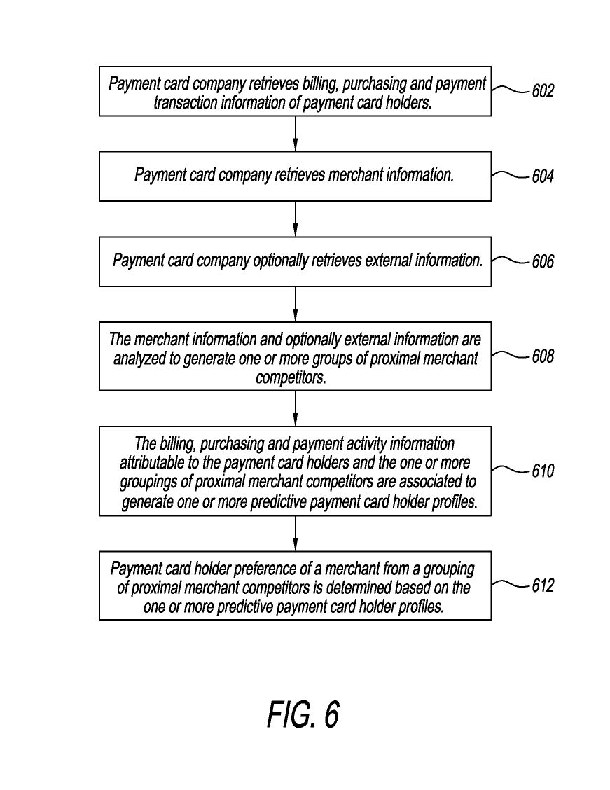

In accordance with the method of the present disclosure, payment card holder preference of a merchant from a grouping of proximal merchant competitors can be determined. Referring to FIG. 6, the method involves a payment card company (part of the payment card company network 150 in FIG. 1) retrieving, from one or more databases, information including activities and characteristics attributable to one or more payment card holders. The information retrieved at 602 comprises payment card billing, purchasing and payment transactions, and optionally demographic and/or geographic information. The payment card company also retrieves at 604, from one or more databases, information including merchant information attributable to one or more payment card holders. The merchant information includes, for example, merchant name, merchant geography, merchant line of business, and the like. The payment card company optionally retrieves, from one or more databases, external information at 606. The external information at 606 includes, for example, geographic data, firmographic information, advertisement data, and the like.

The merchant information at 604 and optional external information at 606 are analyzed at 608 to generate one or more logical groupings of proximal merchant competitors. The groupings of proximal merchant competitors include, for example, merchants in the same line of business, merchants close enough to represent direct competition, and the like. See, for example, the illustrative merchant groupings or categorizations (e.g., automotive fuel, grocery stores, eating places and accommodations) shown in FIG. 4. Standard statistical techniques (e.g., clustering, regression, correlation, segmentation, raking, and the like) can be used to construct logical groupings of proximal merchant competitors.

The logical groupings of proximal merchant competitors can then be associated at 610 with the payment card holder transactions. For each payment card transaction, it can be determined what local merchant competitors were available to the payment card holder. Factors can be recorded that may have influenced the payment card holder's choice or preference such as distance of the merchant competitor to the merchant that the payment card holder selected, information about the merchant that the payment card holder selected and the merchant(s) that were not selected can be summarized (e.g., average purchase amount, store hours, and the like), and other information such as local advertising, incentives, coupons, and the like.

One or more predictive payment card holder profiles are generated at 610 based on the behavioral information and intent of the one or more payment card holders. The one or more payment card holders have a propensity to carry out certain activities at certain times based on the one or more predictive payment card holder profiles.

The predictive payment card holder profiles can predict which merchant a payment card holder is likely to choose, given a choice between two merchants. For example, a payment card holder prefers McDonalds® to Burger King®. The choice can further be quantified, for example, a payment card holder prefers McDonalds® to Burger King® in 3 out of 4 occasions.

The predictive payment card holder profiles can predict which merchant a payment card holder is likely to choose, given a choice between three or more merchants. For example, a payment card holder prefers Merchant A out of the set of Merchant A, Merchant B and Merchant C. The choice can further be quantified, for example, ranking of Merchants A, B and C based on the likelihood the payment card holder will choose each merchant among its competitors. Factors that can influence payment card holder choice or preference include, for example, distance willing to travel for a preferred merchant, influence of local advertising, influence of marketing incentives (e.g., coupons), and the like.

One or more algorithms can be employed to predict which merchant a payment card holder will choose given a choice of one or more specific competitors, using any of a variety of known mathematical techniques. For example, a payment card holder's purchases can be examined during the first 6 month period of a calendar year (pre-period). The preferences are recorded that the same payment card holder displayed during the second 6 month period of a calendar year (post-period). An algorithm is then developed that will use the pre-period data to predict post-period activity. Standard statistical techniques (e.g., clustering, regression, correlation, segmentation, raking, and the like) can be used to develop an algorithm that will use the pre-period data to predict post-period activity. The output of the algorithms can include formulas for determining a choice among a given set of merchant competitors, a method of quantifying the strength of the prediction, for example, a strong preference or a weak preference.

Payment card holder preference of a merchant from a grouping of proximal merchant competitors can be determined at 612 based on the one or more predictive payment card holder profiles.

Several applied insights result from the method of the present disclosure. One applied insight is to create a process of summarizing and compiling relevant data points at the individual level and at the merchant level. Data points at the individual level include, for example, indicators of preference for individual merchants, indicators of preference for one merchant over each of that merchant's competitors (1 versus 1), indicators of preference of one merchant over different sets of that merchant's competitors (1 versus many), other factors that have been determined to be relevant when gauging payment card holder preference, and the like. Data points at the merchant level include, for example, local competitive set, factors that have been determined to be relevant when gauging payment card holder preference, and the like. Additional factors include, for example, seasonal factors (e.g., holidays, peak seasons, weather, and the like), firmographics, travel time, advertising data, marketing data, and the like.

An infrastructure can be created to parse the compiled data and generate a prediction. For example, general data (e.g., transaction data) and/or purpose-built data (e.g., preference quantifier) is read, a prediction is generated, and the prediction is stored and made available to downstream processes (e.g., coupon targeting engine).

Outputs from the method are many and include, for example, payment card holder identification, merchant identification, competitive set identification, payment card holder preference, quantification of payment card holder preference (e.g., strength of the prediction), and the like.

Several applications result from the method of the present disclosure. For example, a hotel wants to identify cardholders that seem to prefer their competitor's lodging so that they can target payment card holders with a “rich” offer in an attempt to capture their future business.

Another example, mapping software recognizes that a payment card holder is looking to eat lunch during a road trip. There is a McDonalds® and a Burger King® off the next exit. If it is predicted that the payment card holder prefers McDonalds®, Burger King® may want to send a targeted offer to the payment card holder in order to win their business. If it is predicted that the payment card holder already prefers Burger King®, Burger King® may choose to do nothing.

Yet another example, a payment card holder indicates to mapping software that he or she is looking to eat lunch while on a road trip. With information about the payment card holder's preference, the mapping software can recommend that the payment card holder bypass the next exit and instead travel to the next city where the choices align better with the payment card holder's preference.

In accordance with the method of the present disclosure, one or more predictive payment card holder profiles are generated based at least in part on the first set of information, the second set of information and optionally the third set of information. Predictive payment card holder profiles can be selected based on the information obtained and stored in the one or more databases. Again, the groups of one or more databases, can be the same or overlap or completely different one or more databases. The selection of information for representation in the predictive payment card holder profiles can be different in every instance. In one embodiment, all information stored in each database can be used for selecting predictive payment card holder profiles. In an alternative embodiment, only a portion of the information is used. The generation and selection of predictive payment card holder profiles can be based on specific criteria.

Predictive payment card holder profiles are generated from the information obtained from each database. The information is analyzed, extracted and correlated by, for example, a financial transaction processing company (e.g., a payment card company), and can include financial account information, merchant information, external information, performing statistical analysis on financial account information, the merchant information and the external information, finding correlations between account information, merchant information, external information and payment card holder behaviors, predicting future payment card holder behaviors based on account information, merchant information and external information, relating information on a financial account, a merchant and external information with other financial accounts, merchants and external information, or any other method of review suitable for the particular application of the data, which will be apparent to persons having skill in the relevant art.

Activities and characteristics attributable to the payment card holders based on the one or more predictive payment card holder profiles are identified. The payment card holders have a propensity to carry out certain activities and to exhibit certain characteristics based on the one or more predictive payment card holder profiles. The activities and characteristics attributable to the payment card holders and based on the one or more predictive payment card holder profiles are conveyed by the financial transaction processing entity to the entity making the targeted offer. This conveyance enables a targeted offer to be made by the entity to the payment card holders. The transmittal can be performed by any suitable method as will be apparent to persons having skill in the relevant art.

Predictive payment card holder profiles can be defined based on geographical or demographical information, including but not limited to, geography, age, gender, income, marital status, postal code, income, spending propensity, and familial status. In some embodiments, predictive payment card holder profiles can be defined by a plurality of geographical and/or demographical categories. For example, a predictive payment card holder profile can be defined for any card holder who engages in spending activity at a merchant.

Predictive payment card holder profiles can also be based on behavioral variables. For example, the financial transaction processing entity database can store information relating to financial transactions. The information can be used to determine an individual's likeliness to spend at a particular merchant. An individual's likeliness to spend can be represented generally, or with respect to a particular industry (e.g., electronics), retailer (e.g., Macy's®), brand (e.g., Apple®), or any other criteria that can be suitable as will be apparent to persons having skill in the relevant art. An individual's behavior can also be based on additional factors, including but not limited to, time, location, and season. For example, a predictive payment card holder profile can be based on payment card holders who are likely to spend on electronics during the holiday season, or on sporting goods throughout the year. The factors and behaviors identified can vary widely and can be based on the application of the information.

Behavioral variables can also be applied to generated predictive payment card holder profiles based on the attributes of the entities. For example, a predictive payment card holder profile of specific geographical and demographical attributes can be analyzed for spending behaviors. Results of the analysis can be assigned to the predictive payment card holder profiles.

In an embodiment, the information retrieved from each database can be analyzed to determine behavioral information of the payment card holders. Also, information related to an intent of the payment card holders can be extracted from the behavioral information. The predictive payment card holder profiles can be based upon the behavioral information of the payment card holders and the intent of the payment card holders. The predictive payment card holder profiles can be capable of predicting behavior and intent in the payment card holders.

Predictive payment card holder profiles can be developed, for example, to examine spend behaviors and create spend associations at particular merchants. A spend association can be a set of spend behaviors that predict another spend behavior. For example, people that tend to purchase jewelry at a particular merchant display the following spend behaviors at other merchants: spend at Macy's®, spend on travel on particular cruise ships, and so forth. Payment card holder preference of a merchant from a grouping of proximal merchant competitors can be generated based on the predictive payment card holder profiles.

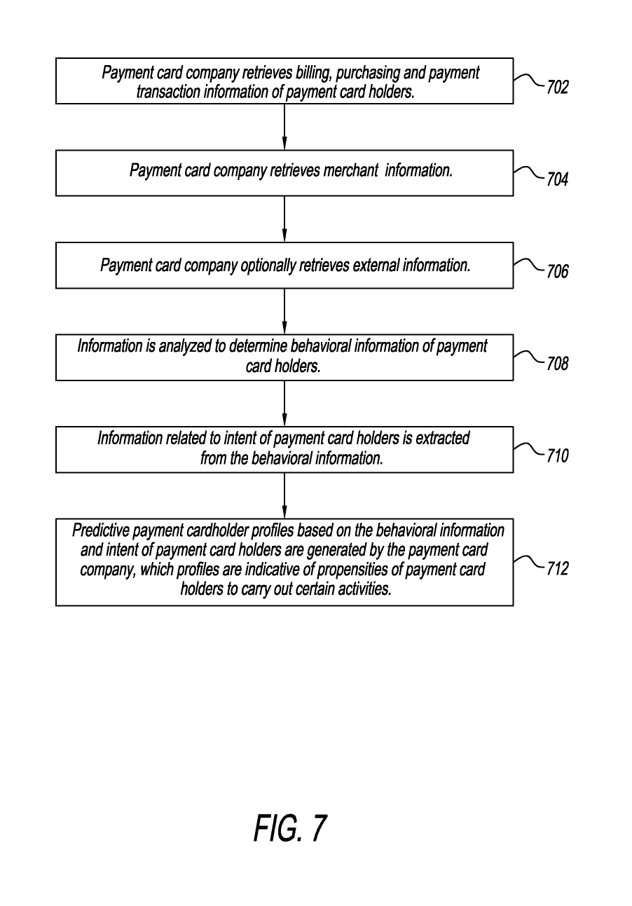

A method for generating one or more predictive payment card holder profiles is an embodiment of this disclosure. Referring to FIG. 7, the method includes a payment card company (part of the payment card company network 150 in FIG. 1) retrieving, from one or more databases, information including activities and characteristics attributable to one or more payment card holders 702. The information at 702 includes payment card billing, purchasing and payment transactions, and optionally demographic and/or geographic information. The payment card company also retrieves at 704, from one or more databases, information including merchant information attributable to one or more payment card holders. The merchant information at 704 includes, for example, merchant name, merchant geography, merchant line of business, and the like. The payment card company optionally retrieves, from one or more databases, external information at 706. The external information at 706 includes, for example, geographic data, firmographic information, advertisement data, and the like. The information is analyzed at 708 to determine behavioral information of the one or more payment card holders. At 710, information related to an intent of the one or more payment card holders is extracted from the behavioral information. One or more predictive payment card holder profiles are generated at 712 based on the behavioral information and intent of the one or more payment card holders. The one or more payment card holders have a propensity to carry out certain activities at certain times based on the one or more predictive payment card holder profiles.

In analyzing information to determine behavioral information, intent (payment card holder) and other payment card holder attributes are considered. Developing intent of payment card holders involves profiles that predict specific spend behavior at certain times in the future and desirable spend behaviors at certain dates and times.

Predictive payment card holder profiles can equate to purchase behaviors. There can be different degrees of predictive payment card holder profiles with the ultimate behavior being a purchase.

There is the potential for numerous predictive payment card holder profiles including, for example, merchants/industries (e.g., consumer electronics, QSR), categories (e.g., online spend, cross border), geography spend (e.g., spend in New York City, spend in London), geography residence (e.g., live in New York City, live in Seattle), day/time spend (e.g., weekday spend, lunch time spend), calendar spend (e.g., spend a lot around Christmas, spend a lot on flowers before Valentine's Day), top number of merchants, and the like.

The payment card holder profiles and information can be collected and aggregated at the transaction level. The payment card holder profiles and information can be aggregated by customer. For example, Bob prefers a Mobil® gas station to most any other gas station. If a Mobil® gas station is not present, his choice of gas station seems to be arbitrary. The payment card holder profiles and information can also be collected in the aggregate. For example, opening a Wendy's® next to a McDonald's® tends to result in a drop in McDonald's® volume. Opening a Burger King® next to a McDonald's® generally will not impact the sales at McDonald's®.

Other payment card holder attributes that are part of the information include, for example, demographics (e.g., age, gender, and the like).

The method further includes conveying to an entity the activities and characteristics attributable to the one or more payment card holders based on the one or more predictive payment card holder profiles, to enable the entity to make a targeted offer to the one or more payment card holders. The one or more predictive payment card holder profiles are capable of predicting behavior and intent in the one or more payment card holders. The one or more payment card holders are people and/or businesses; the activities attributable to the one or more payment card holders are financial transactions associated with the one or more payment card holders; and the characteristics attributable to the one or more payment card holders are merchant preference, geographical characteristics and/or demographics of the one or more payment card holders.

A behavioral propensity score is used for conveying to the entity the activities and characteristics attributable to the one or more payment card holders based on the one or more predictive payment card holder profiles. The behavioral propensity score is indicative of a propensity to exhibit a certain behavior.

Potential payment card holders can represent a wide variety of categories and attributes. In one embodiment, potential payment card holder can be created based on spending propensity of a spending index in a particular industry and at a particular merchant. Industries can include, as will be apparent to persons having skill in the relevant art, restaurants (e.g., fine dining, family restaurants, fast food), apparel (e.g., women's apparel, men's apparel, family apparel), entertainment (e.g., movies, professional sports, concerts, amusement parks), accommodations (e.g., luxury hotels, motels, casinos), retail (e.g., department stores, discount stores, hardware stores, sporting goods stores), automotive (e.g., new car sales, used car sales, automotive stores, repair shops), travel (e.g., domestic, international, cruises), and the like. Each industry can include a plurality of potential payment card holders (e.g., based on location, income groups, and the like).

Potential payment card holders can also be based on predictions of future behavior. For instance, a financial transaction processing company can analyze financial account information and behavioral information to predict future behavior of a potential payment card holder.

Potential payment card holders can also be aligned with other similar potential payment card holders. Similar potential payment card holders can be determined by similarities in, for example, the payment card holder parameters (e.g., nearby postal codes), or in the entities contained in the predictive payment card holder profiles (e.g., a larger number of card holders common to both card holders). In one embodiment, the financial transaction processing company can create potential payment card holders based on received parameters, which can be aligned to payment card holders created by a third party on the same parameters yet include different entities or behaviors. The process and parameters for the alignment of potential payment card holders can be dependent on the application of the payment card holders, as will be apparent to persons having skill in the relevant art.

A financial transaction processing company can analyze the generated predictive payment card holder profiles (e.g., by analyzing the stored data for each entity including the predictive payment card holder profile) for behavioral information (e.g., spend behaviors and propensities). In some embodiments, the behavioral information can be represented by a behavioral propensity score. Behavioral information can be assigned to each corresponding predictive payment card holder profile, or can be assigned to an audience of predictive payment card holder profiles.

Predictive payment card holder profiles or behavioral information can be updated or refreshed at a specified time (e.g., on a regular basis or upon request of a party). Updating predictive payment card holder profiles can include updating the entities included in each predictive payment card holder profile with updated demographic data and/or updated financial data and/or updated merchant data. Predictive payment card holder profiles can also be updated by changing the attributes that define each predictive payment card holder profile, and generating a different set of behaviors. The process for updating behavioral information can depend on the circumstances regarding the need for the information itself.

Although the above methods and processes are disclosed primarily with reference to financial data, merchant data, external data and spending behaviors, it will be apparent to persons having skill in the relevant art that the predictive payment card holder profiles can be beneficial in a variety of other applications. Predictive payment card holder profiles can be useful in the evaluation of payment card holder data that may need to be protected.

For instance, predictive payment card holder profiles can have useful applications in measuring the effectiveness of advertising or other consumer campaigns. A party can desire to discover the effectiveness of a particular advertising campaign in reaching a specific set of payment card holders.

For example, a consumer electronics store may want to know the effectiveness of an advertising campaign initiated by the store and directed towards male payment card holders of a specific age and income group. The store can provide the financial transaction processing company with the demographic (e.g., demographical and geographical) data corresponding to the market. The financial transaction processing company can obtain financial transaction data, merchant data and external data. The financial transaction processing company can identify predictive payment card holder profiles with corresponding financial transaction data, merchant data and external data, and summarize relevant spend behaviors for the identified predictive payment card holder profiles. Summary of the relevant spend behaviors (e.g., showing an increase or decrease in spending at the consumer electronic store at particular times and dates) for each predictive payment card holder profile (e.g., including the predictive payment card holder profiles of ideal payment card holders) can be provided to the consumer electronics store.

Predictive payment card holder profile data can also be combined or matched with other sources of data. For example, other transaction processing agencies, advertising firms, advertising networks, publishers, and the like can provide information on consumer groupings of their own. The financial transaction processing company can link or match the received consumer groupings, such as by matching groupings to generated predictive payment card holder profiles based on geographical or demographical data.

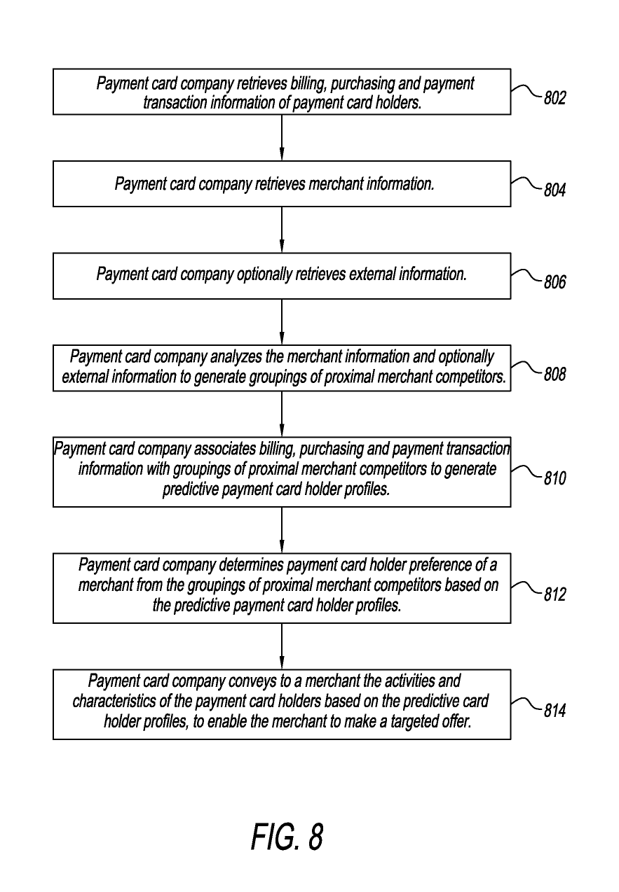

FIG. 8 illustrates an exemplary method for making a targeted offer by an entity to a payment card holder. At step 802, a payment card company (part of the payment card company network 150 in FIG. 1) retrieves, from one or more databases, information including activities and characteristics attributable to one or more payment card holders. The information at 802 includes payment card billing, purchasing and payment transactions, and optionally demographic and/or geographic information. The payment card company also retrieves, from one or more databases, information including merchant information attributable to one or more payment card holders at 804. The merchant information at 804 includes, for example, merchant name, merchant geography, merchant line of business, and the like. The payment card company optionally retrieves, from one or more databases, external information at 806. The external information at 806 includes, for example, geographic data, firmographic information, advertisement data, and the like.

The payment card company analyzes the second set of information and optionally the third set of information at 808 to generate one or more groupings of proximal merchant competitors. The payment card company associates the purchasing and payment activity information attributable to one or more payment card holders and the one or more groupings of proximal merchant competitors at 810 to generate one or more predictive payment card holder profiles. The payment card company then determines at 812 payment card holder preference of a merchant from a grouping of proximal merchant competitors based on the one or more predictive payment card holder profiles.

The payment card company generates predictive payment card holder profiles based on the purchasing and payment activity information, merchant information and optionally external information, and identifies activities and characteristics attributable to potential purchasers based on the predictive payment card holder profiles. Activities and characteristics attributable to the payment card holders are identified based on the one or more predictive payment card holder profiles. The payment card holders have a propensity to carry out certain activities and to exhibit certain characteristics based on the one or more predictive payment card holder profiles.

The activities and characteristics attributable to the payment card holders based on the one or more predictive payment card holder profiles are conveyed to an entity (e.g., merchant) at 814, to enable the entity to make a targeted offer to the payment card holders. In an embodiment, the payment card company conveys to the entity at 814 a behavioral propensity score based on the predictive payment card holder profiles. The score is indicative of a propensity of a potential purchaser to exhibit a certain behavior.

At step 814, the predictive payment card holder profiles are used to predict behavior and intent in payment card holders (e.g., the above predictive payment card holder profile examples are used to predict individuals likely to purchase consumer electronics or sporting goods in the next week). The entity executes promotions to targeted potential purchasers through a mobile channel or e-mail.

In an embodiment, the entity provides feedback to the payment card company to enable the payment card company to monitor and track impact of targeted offers. This “closed loop” system allows an entity to track advertising campaigns, measure efficiency of the targeting, and make any improvements for the next round of campaigns.

One or more algorithms can be employed to determine formulaic descriptions of the assembly of the payment card holder information including payment card billing, purchasing and payment transactions, merchant information, and external information (e.g., demographic and/or geographic information), using any of a variety of known mathematical techniques. These formulas in turn can be used to derive or generate one or more predictive payment card holder profiles using any of a variety of available trend analysis algorithms.

Where methods described above indicate certain events occurring in certain orders, the ordering of certain events can be modified. Moreover, while a process or method depicted as a flowchart, block diagram, or the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is stated herein that something is “based on” something else, it can be based on one or more other things as well. In other words, unless expressly indicated otherwise, as used herein “based on” means “based at least in part on” or “based at least partially on.”

It should be understood that the present disclosure includes various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method for determining payment card holder preference of a merchant from a grouping of proximal merchant competitors, the method comprising:
retrieving, from one or more databases, a first set of information including purchasing and payment activity information attributable to one or more payment card holders;
retrieving, from one or more databases, a second set of information including merchant information associated with the purchasing and payment activity;
optionally retrieving, from one or more databases, a third set of information including external information;
analyzing the second set of information and optionally the third set of information to generate one or more groupings of proximal merchant competitors;
associating the purchasing and payment activity information attributable to one or more payment card holders and the one or more groupings of proximal merchant competitors to generate one or more predictive payment card holder profiles; and
determining payment card holder preference of the merchant from the grouping of proximal merchant competitors based on the one or more predictive payment card holder profiles.

2. The method of claim 1, further comprising algorithmically determining payment card holder preference of the merchant from the grouping of proximal merchant competitors based on the one or more predictive payment card holder profiles.

3. The method of claim 1, further comprising:
identifying activities and characteristics attributable to the one or more payment card holders based on the one or more predictive payment card holder profiles.

4. The method of claim 3, wherein the one or more payment card holders are people and/or businesses, the activities attributable to the one or more payment card holders are financial transactions, and the characteristics attributable to the one or more payment card holders are merchant preference, demographics and/or geographical characteristics.

5. The method of claim 3, further comprising:
conveying to an entity the activities and characteristics attributable to the one or more payment card holders based on the one or more predictive payment card holder profiles, to enable the entity to make a targeted offer to the one or more payment card holders.

6. The method of claim 5, wherein the entity makes a targeted offer to the one or more payment card holders by e-mails, text messages, phone calls or television.

7. The method of claim 5, further comprising:
tracking and measuring impact of the targeted offer based at least in part on purchasing and payment activities attributable to the one or more payment card holders, after the targeted offer has been made.

8. The method of claim 5, wherein the one or more predictive payment card holder profiles provides a behavioral propensity score that is used for conveying to the entity the activities and characteristics attributable to the one or more payment card holders based on the one or more predictive payment card holder profiles, and wherein the behavioral propensity score is indicative of a propensity to exhibit a certain behavior.

9. The method of claim 5, wherein the entity comprises one or more merchant entities.

10. The method of claim 1, further comprising:
analyzing the first set of information, the second set of information and optionally the third set of information to determine behavioral information of the one or more payment card holders; and
extracting information related to an intent of the one or more payment card holders from the behavioral information.

11. The method of claim 10, wherein the one or more predictive payment card holder profiles are based upon the behavioral information of the one or more payment card holders and the intent of the one or more payment card holders.

12. The method of claim 1, wherein the first set of information comprises purchasing and payment transactions by the one or more payment card holders, and optionally demographic and/or geographic information.

13. The method of claim 1, wherein the second set of information comprises merchant name, merchant address, merchant location(s) of business, merchant category, and optionally demographic and/or geographic information.

14. The method of claim 1, wherein the third set of information comprises geographic data, firmographic information, advertisement data, and optionally demographic information.

15. A system for determining payment card holder preference of a merchant from a grouping of proximal merchant competitors, the system comprising:
one or more databases comprising a first set of information including purchasing and payment activity information attributable to one or more payment card holders;
one or more databases comprising a second set of information including merchant information associated with the purchasing and payment activity;
optionally one or more databases comprising a third set of information including external information;
a processor configured to:
analyze the second set of information and optionally the third set of information to generate one or more groupings of proximal merchant competitors;
associate the purchasing and payment activity information attributable to one or more payment card holders and the one or more groupings of proximal merchant competitors to generate one or more predictive payment card holder profiles; and
determine payment card holder preference of the merchant from the grouping of proximal merchant competitors based on the one or more predictive payment card holder profiles.

16. The system of claim 15, wherein the processor is configured to:
algorithmically determine payment card holder preference of the merchant from the grouping of proximal merchant competitors based on the one or more predictive payment card holder profiles; and
identify activities and characteristics attributable to said one or more payment card holders based on the one or more predictive payment card holder profiles.

17. The system of claim 16, further comprising:
a device for conveying to an entity the activities and characteristics attributable to the one or more payment card holders based on the one or more predictive payment card holder profiles, to enable the entity to make a targeted offer to the one or more payment card holders.

18. The system of claim 17, wherein the processor is configured to:
track and measure impact of the targeted offer based at least in part on purchasing and payment activities attributable to said one or more payment card holders, after the targeted offer has been made.

19. The system of claim 15, wherein the processor is configured to:
analyze the first set of information, the second set of information and optionally the third set of information to determine behavioral information of the one or more payment card holders; and
extract information related to an intent of the one or more payment card holders from the behavioral information.

20. The system of claim 15, wherein the first set of information comprises purchasing and payment transactions by the one or more payment card holders, and optionally demographic and/or geographic information, wherein the second set of information comprises merchant name, merchant address, merchant location(s) of business, merchant category, and optionally demographic and/or geographic information, and wherein the third set of information comprises geographic data, firmographic information, advertisement data, and optionally demographic information.

21. The system of claim 17, wherein the one or more predictive payment card holder profiles provides a behavioral propensity score that is used for conveying to the entity the activities and characteristics attributable to the one or more payment card holders based on the one or more predictive payment card holder profiles, and wherein the behavioral propensity score is indicative of a propensity to exhibit a certain behavior.

22. A method for generating one or more predictive payment card holder profiles, the method comprising:
retrieving, from one or more databases, a first set of information including purchasing and payment activity information attributable to one or more payment card holders;
retrieving, from one or more databases, a second set of information including merchant information associated with the purchasing and payment activity;
optionally retrieving, from one or more databases, a third set of information including external information;
analyzing the first set of information, the second set of information and optionally the third set of information to determine behavioral information of the payment card holders;
extracting information related to an intent of the payment card holders from the behavioral information; and
generating the one or more predictive payment card holder profiles based on the behavioral information and intent of the payment card holders, wherein the payment card holders have a propensity to carry out certain activities based on the one or more predictive payment card holder profiles.

23. The method of claim 22, further comprising:
conveying to an entity one or more activities and characteristics attributable to the payment card holders based on the one or more predictive payment card holder profiles, to enable the entity to make a targeted offer to the payment card holders.
